(19) United States
(12) Patent Application Publication
(10) Pub. No.: US 2012/0260063 A1
(43) Pub. Date: Oct. 11, 2012

(54) MODULAR, DETACHABLE COMPUTE LEAF FOR USE WITH COMPUTING SYSTEM

(75) Inventors: Voya R. Markovich, Endwell, NY (US); How T. Lin, Vestal, NY (US); Benson Chan, Vestal, NY (US); Frank D. Egitto, Binghamton, NY (US)

(73) Assignee: ENDICOTT INTERCONNECT TECHNOLOGIES, INC., Endicott, NY (US)

(21) Appl. No.: 13/082,599

(22) Filed: Apr. 8, 2011

(51) Int. Cl. G06F 15/76; G06F 9/02

(52) U.S. Cl. 712/29; 712/E09.002

(57) ABSTRACT

A detachable, logic leaf module having dendritic projections on a surface is connected to a recessed area on the surface of a cluster interface board. The projections are used for electrically connecting the logic module device to the cluster interface board or the like, the projections on the surface of the logic leaf being flexibly and conductively wired to the receiving area on the surface of the cluster interface board. The logic leaf connector is removable without the need for solder softening thermal cycles or special tools, and permits the simple removal or replacement of an individual leaf at any time.

### FIELD OF THE INVENTION

The present invention relates to computing systems, and more particularly, to an individual, removably detachable compute module leaf for use in the formation of 3-D replaceable compute modules.

### BACKGROUND OF THE INVENTION

As computers have gained processing speed and circuit count over time according to Moore's Law, computer footprints and signal paths have become smaller. Speeds have increased to the point that the distances between connection points constrain the parallel computing device, causing it to waste processing cycles while the central processing unit or units wait for responses to queries. In an interconnected multiprocessing node supercomputer, that can cause problems with the execution of the desired program. With ever increasing processing core clock cycle speeds, designers have to take into account electrical signal propagation (i.e., the speed of light) in their design of circuitry inside processing nodes in a multiprocessor supercomputer. The packaging of a multiple node supercomputer also must keep up with the density of both physical properties and electrical properties.

As computer devices have become more complex and miniaturized, the ability to repair the devices has become more complex also. The energy density and cooling capacity requirements of the current generation of high speed computing devices place great emphasis on the design for repair or replacement of the modules that make up the complete device.

A supercomputer is at the front line of current processing capacity, particularly speed of calculation. Supercomputers, introduced in the 1960s, were designed primarily by Seymour Cray at Control Data Corporation (CDC), and later at his own company, Cray Research. Today, supercomputers are typically one-of-a-kind custom designs produced by traditional companies such as Cray, IBM and Hewlett-Packard. The Cray XT5 Jaguar, located at Oak ridge National Laboratory, is the fastest supercomputer in the world currently.

The term supercomputer itself is rather fluid. Today's supercomputer tends to become tomorrow's ordinary computer. CDC's early machines were simply very fast scalar processors, some ten times the speed of the fastest machines offered by other companies. In the 1970s most supercomputers were dedicated to running a vector processor, and many of the newer companies developed their own such processors. In the early and mid-1980s, machines with a modest number of vector processors working in parallel became the standard. Typical numbers of processors were in the range of four to sixteen. In the later 1980s and 1990s, attention turned from vector processors to massive parallel processing systems with thousands of “ordinary” CPUs, some being off the shelf units and others being custom designs. Parallel designs currently are based on off the shelf server-class microprocessors. Most modern supercomputers are now highly tuned computer clusters using commodity processors combined with custom interconnects.

Massively parallel computing structures (also referred to as “ultra-scale computers”) interconnect large numbers of compute nodes, generally in the form of very regular structures, such as grids, lattices or torus configurations. The conventional approach for the most cost/effective ultra-scale computers has been to use standard processors configured in uni-processors or symmetric multiprocessor (SMP) configurations, wherein the SMPs are interconnected with a network to support message passing communications. Today, these supercomputing machines exhibit computing performance achieving teraOPS-scale.

The semiconductor devices used in computers and similar items are typically provided with a high density of electrical contacts on one surface, arranged in a patterned array with constant dimensions and a small spacing or pitch between the centers of the contacts. The contacts may consist of patterned pads or bumps.

Historically, in first level packaging the chips were mounted on a rigid carrier with matching electrical contacts, encapsulated and hermetically sealed in metal or plastic packages. The carrier redistributed the electrical contacts over a larger area and made it compatible for mounting on a printed circuit board (PCB) or printed wiring board (PWB) known as second level packaging. Conventionally, the electrical connection between the chip and carrier in the first level package has been permanent by means of solder, wirebond and similar processes, and not amenable to easy removal or reworking. The second level interconnections of the carrier to the PWB have similarly been permanent or at best difficult to rework via solder.

Using conventional interconnection methods give rise to a number of problems. The mismatch in the coefficient of thermal expansion (CTE) of the chip substrate, usually silicon, and the carrier result in stress build-up during the assembly process and during operation of the device. Rigid carriers similarly acquire and retain residual stress during second level assembly. Such stress often leads to the early failure of the electrical contacts either at the first or the second level interconnections.

Secondly, problems associated with rigid and flexible carriers can be related to testing, burn-in, and removal/reworking of interconnects. The devices require firm, reliable electrical/ohmic contacts with the carrier and PWB during testing and burn-in. However the process also demands easily detachable chip-to-carrier or carrier-to-PWB joints, should the device or the electrical interconnects be found defective. Conventional rework methods introduce additional thermal cycles on the assembly and often damage the device or the PWB.

### DISCUSSION OF RELATED ART

U.S. Pat. No. 5,207,585, issued May 4, 1993 to Byrnes et al., for THIN INTERFACE PELLICLE FOR DENSE ARRAYS OF ELECTRICAL INTERCONNECTS, discloses a thin interface pellicle probe for making temporary or permanent interconnections to pads or bumps on a semiconductor device. The pads or bumps may be arranged in high-density patterns incorporating an electrode for each pad or bump. The electrode has a raised portion for penetrating the surface of the pad or bump to create sidewalls to provide a clean contact surface. The electrode has a recessed surface to limit the penetration of the raised portion. The electrodes may be affixed to a thin flexible membrane to permit each contact to have independent movement over a limited distance and of a limited rotation.

U.S. Pat. No. 6,242,282, issued Jun. 5, 2001 to Fillion et al., for CIRCUIT CHIP PACKAGE AND FABRICATION METHOD, discloses a method for packaging at least one circuit chip that includes providing an interconnect layer including insulative material. The initial metallization pattern contains at least one substrate via extending the through the material to connect metallized portions, and at least one chip via connected. Positioning at least one circuit chip on the substrate with a chip pad of the circuit chip being aligned with the chip via. Patterning the connection metallization on selected portions of the interconnect layer and in the vias so as to extend to the second metallized portion and to the chip pad. In related embodiments vias are pre-metallized and coupled to chip pads of the circuit chips by an electrically conductive binder.

U.S. Pat. No. 6,156,484, issued Dec. 5, 2000 to Bassous et al., for GRAY SCALE ETCHING FOR THIN FLEXIBLE INTERPOSER, discloses a sculpted probe pad and a gray scale etching process for making arrays of such probe pads on a thin flexible interposer. Probe pads are used for testing the electrical integrity of microelectronic devices at terminal metallurgy. Also used in the etching process is a fixture for holding the substrate and a mask for 1-step photolithographic exposure.

U.S. Pat. No. 6,618,941, issued Sep. 16, 2003, to Campbell et al., for METHOD OF FORMING FREESTANDING METAL DENDRITES, discloses a technique for making acicular, branched, conductive dendrites, and a technique for using the dendrites to form a conductive compressible pad-on-pad connector. To form the dendrites, a substrate is provided on which dendrites are grown, preferably on a metal film. The dendrites are then removed from the substrate, preferably by etching metal from the substrate. The so-formed dendrites are incorporated into a compressible dielectric material, which then forms a compressible pad-on-pad connector between two conducting elements, such as connector pads on electrical devices, e.g. an I/C chip mounted on a substrate, such as a chip carrier.

U.S. Pat. No. 5,137,461, issued Aug. 11, 1992, to Bindra et al., for SEPARABLE ELECTRICAL CONNECTION TECHNOLOGY, discloses a separable and reconnectable connection for electrical equipment that is suitable for miniaturization. Vertical interdigitating members are integrally attached and protrude from a planar portion. These members are accommodated in the control of damage during lateral displacement that occurs on mating with an opposite similar contact. Displacement damage is averted through accommodating lateral stresses by providing one or more of a conformal opposing contact and by strengthening through coating and base reinforcement and a deformable coating. The contacts are provided with a surrounding immobilizing material that enhances rigidity.

U.S. Pat. No. 7,555,566, issued Jun. 30, 2009 to Blumrich, et al., for MASSIVELY PARALLEL SUPERCOMPUTER, describes a massively parallel supercomputer of hundreds of teraOPS-scale that includes node architectures based upon system-on-a-chip technology. Each processing node comprises a single Application Specific Integrated Circuit (ASIC). Within each ASIC node is a plurality of processing elements each of which consists of a central processing unit and a plurality of floating point processors to enable optimal balance of computational performance, packaging density, low cost, and power and cooling requirements. The plurality of processors within a single node may be used individually or simultaneously to work on any combination of computation or communication as required by the particular algorithm being solved or executed. The system-on-a-chip ASIC nodes are interconnected by multiple independent networks that maximize packet communications throughput and minimize latency.

It is therefore an object of the invention to provide an interconnection method for an individual processing leaf as part of a larger module to optimally achieve maximum levels of connectivity without the permanent joining of interconnections within a supercomputing architecture.

It is another object of the invention to provide an interconnection method for an individual processing leaf as part of a larger module to achieve maximum grouping flexibility of module clusters within a supercomputing architecture.

It is still yet another object of the invention to provide an interconnection method for an individual processing leaf as part of a larger module that is designed for uncomplicated upgrading/replacement within a supercomputing architecture.

### SUMMARY OF THE INVENTION

The present invention is directed to a removable, modular logic leaf that is part of a scalable compute system having a midplane for interconnecting electrical components and a controller concentrator having means for communication among a plurality of modular logic leaves. The logic leaf connector is removable with no need for solder softening thermal cycles, or special tools, and permits the simple removal or replacement of an individual leaf at any time.

### BRIEF DESCRIPTION OF THE DRAWINGS

The objects and advantages of the present invention will become more readily apparent to those skilled in the art after reviewing the following detailed description and the accompanying drawings, wherein:

FIG. 1 is a top view of a module cluster interface board;

FIG. 2 is a side view of a single detachable logic leaf module;

FIG. 3 is a bottom view of the single detachable logic leaf module of FIG. 2;

FIG. 4 is a top view of a single detachable logic leaf module of FIG. 2;

FIG. 5 is a side view of a single detachable logic leaf module of FIG. 2 showing greater detail;

FIG. 6 is a detailed side view of a section A-A of FIG. 5 flex interconnect section;

FIG. 7 is a is a top view of a single module cluster with detachable logic leaves unfolded;

FIG. 8 is a side view of a single module cluster with detachable logic leaves folded into final position of a completed assembly;

FIG. 9 is a top view of a single module cluster with detachable logic leaves folded into final position of a completed assembly; and

FIG. 10 represents an information handling system according to one aspect of the invention, which is capable of utilizing one or more of the electronic packages taught herein.

For the sake of clarity and brevity, like elements and components of each embodiment will bear the same designations throughout the description. The drawings show an embodiment that has four equal sides of a detachable compute module, therefore like elements are not individually designated throughout single figures.

### DESCRIPTION OF THE PREFERRED EMBODIMENT

Generally speaking, the present invention is a high speed and high-density computing system endowed with removable and detachable modular logic leaves that facilitate the field replacement and upgrade of individual modules, both at initial assembly and after deployment in the field.

For a better understanding of the present invention, together with other and further objects, advantages and capabilities thereof, reference is made to the following disclosure and appended claims.

By the term “circuitized substrate” as used herein is meant a substrate structure having at least one (and preferably more) dielectric layer and at least one external conductive layer positioned on the dielectric layer and including a plurality of conductor pads as part thereof. The conductive layers preferably serve to conduct electrical signals, including those of the high frequency type, and is preferably comprised of suitable metals such as copper, again, as this is the thrust of this application.

By the term “electroplating” as used herein is meant a process by which a metal in its ionic form is supplied with electrons to form a non-ionic coating on a desired substrate. The most common system involves: a chemical solution which contains the ionic form of the metal, an anode (positively charged) which may consist of the metal being plated (a soluble anode) or an insoluble anode (usually carbon, platinum, titanium, lead, or steel), and finally, a cathode (negatively charged) where electrons are supplied to produce a film of non-ionic metal.

By the term “electroless plating” (also known as chemical or auto-catalytic plating) as used herein is meant a non-galvanic type of plating method that involves several simultaneous reactions in an aqueous solution, which occur without the use of external electrical power. The reaction is accomplished when hydrogen is released by a reducing agent, normally sodium hypophosphite, and oxidized thus producing a negative charge on the surface of the part.

By the term “electronic package” as used herein is meant a circuitized substrate assembly as taught herein having one or more ICs (e.g., semiconductor chips) positioned thereon and electrically coupled thereto. In a multi-chip electronic package, for example, a processor, a memory device and a logic chip may be utilized and oriented in a manner designed for minimizing the limitation of system operational speed caused by long connection paths. Some examples of such packages, including those with a single chip or a plurality thereof, are also referred to in the art as chip carriers.

By the term “etch” and “etching” as used herein is meant a process by where a surface of a substrate is either selectively etched using a photoresist or covered by a mask prior to plasma treating, both methods are meant to transfer an image onto the substrate for subsequent further processing.

By the term “information handling system” as used herein is meant any instrumentality or aggregate of instrumentalities primarily designed to compute, classify, process, transmit, receive, retrieve, originate, switch, store, display, manifest, measure, detect, record, reproduce, handle or utilize any form of information, intelligence or data for business, scientific, control or other purposes. Examples include personal computers and larger processors such as computer servers and mainframes. Such products are well known in the art and are also known to include PCBs and other forms of circuitized substrates as part thereof, some including several such components depending on the operational requirements thereof.

By the term “laser ablation” as used herein is meant the process of removing material from a solid surface by irradiating it with a laser beam. At low laser flux, the material is heated by the absorbed laser energy and evaporates or sublimes. At high laser flux, the material is typically converted to a plasma. The term laser ablation as used herein refers to removing material with a pulsed laser as well as ablating material with a continuous wave laser beam if the laser intensity is high enough.

By the term “thru-hole” as used herein is meant to include what are also commonly referred to in the industry as blind vias which are openings typically from one surface of a substrate to a predetermined distance therein, internal vias which are vias or openings located internally of the substrate and are typically formed within one or more internal layers prior to lamination thereof to other layers to form the ultimate structure, and plated thru-holes (PTHs), which typically extend through the entire thickness of a substrate. All of these various openings form electrical paths through the substrate and often include one or more conductive layers, e.g., plated copper, thereon. Alternatively, such openings may simply include a quantity of conductive paste or, still further, the paste can be additional to plated metal on the opening sidewalls. These openings in the substrate are formed typically using mechanical drilling or laser ablation, following which the plating and/or conductive paste may be added.

The current embodiment of the invention allows for removable and detachable logic leaves to be joined to a compute module cluster interface board using a flexible, reusable, dendritic connector.

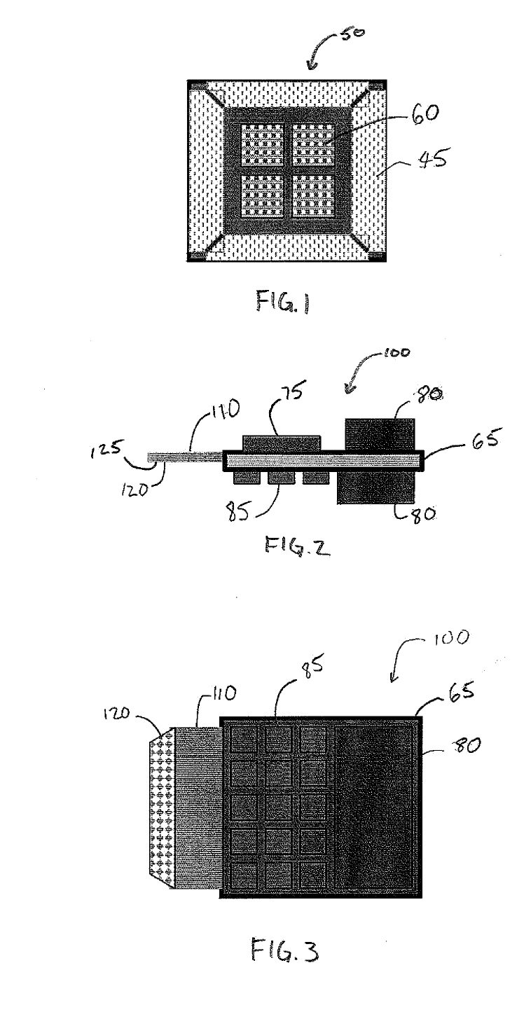

Referring now to FIG. 1, there is shown a top view of a compute module cluster interface board 50 having module cluster connector blocks 60 that allow the interface and communication of the compute module cluster interface board 50, using a dendritic metal structure 45, with an individual detachable logic leaf 100 (FIG. 2). This connection type allows for a structure that includes an array of separate, individual compute modules 70 (FIG. 8) in such a pattern to allow close packing for performance density and allow access for maintenance.

FIG. 2 is a side view of an individual detachable logic leaf 100. Flex lead 110 is normally connected to the compute module cluster interface board 50 by means of a coupling containing a dendritic metal structure 125 similar to Velcro on one surface of flex connector 120. Dendritic metal structures 45 and 125 are similar to Velcro in the fact that if pressure is applied to a region where the two structures 45 and 125 are in close proximity, albeit with more dimensional structure and integrity of the bond. However, when the layers are separated, there is not the characteristic “ripping” sound of Velcro.

Memory 85 is dedicated to serving the local processors 75, of which the processor 75 can be FPGA/ASIC type, and power supplies 80 are shown arrayed on a direct chip attach (DCA)-Z Interconnect 65 such that individual detachable logic leaves 100 are similar and consistent in structure. Flex lead 110 encompasses power, signal, and ground wires for transmission of power and communications the various devices resident on DCA-Z Interconnect 65.

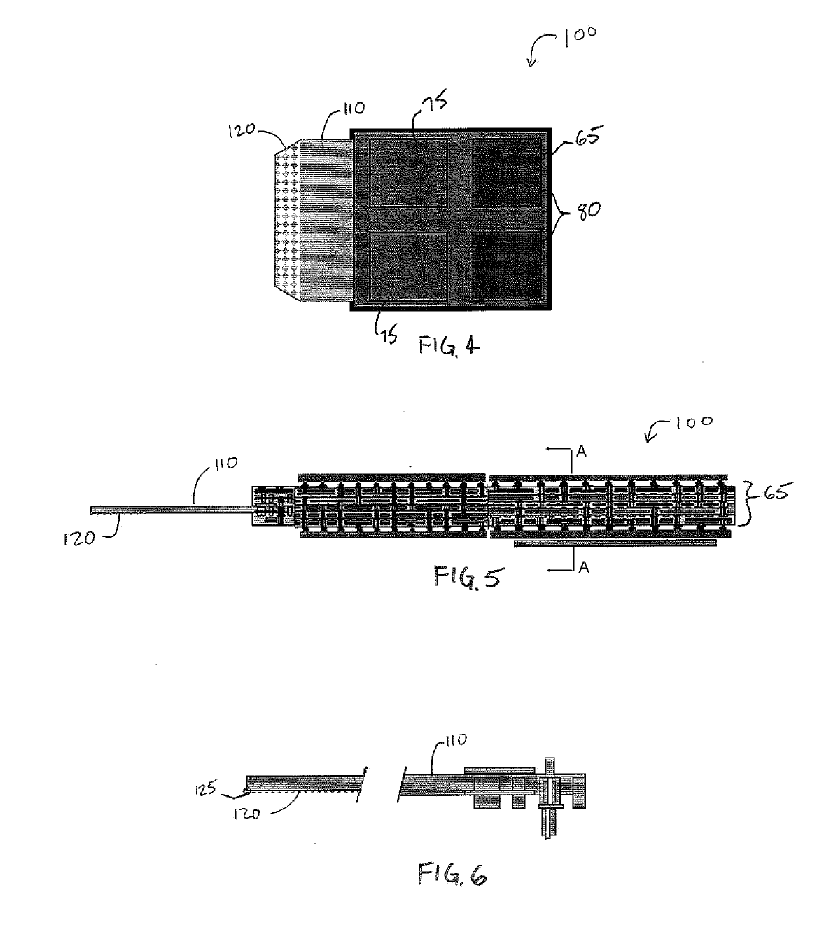

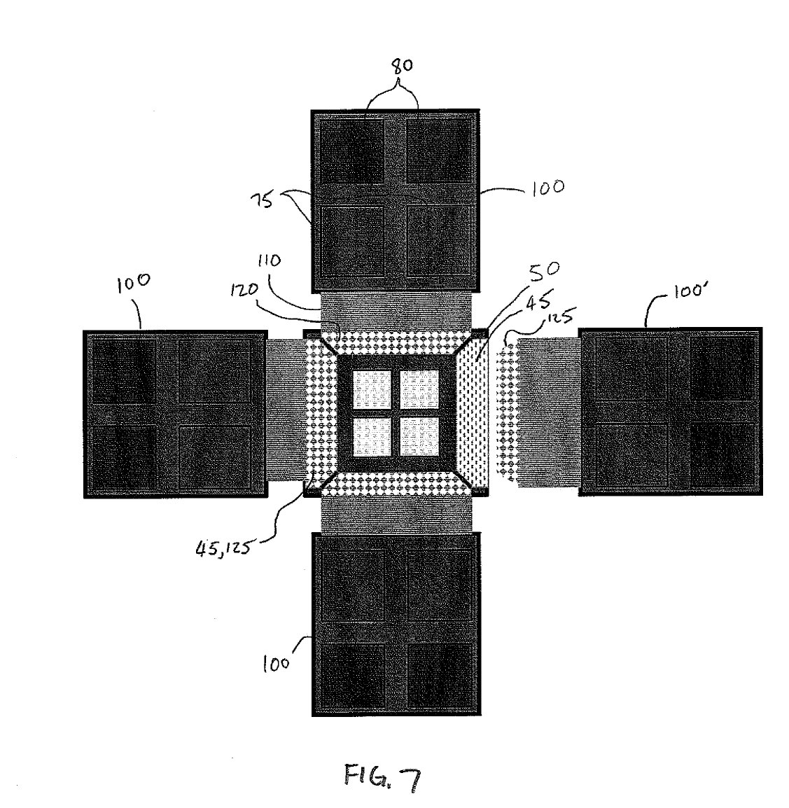

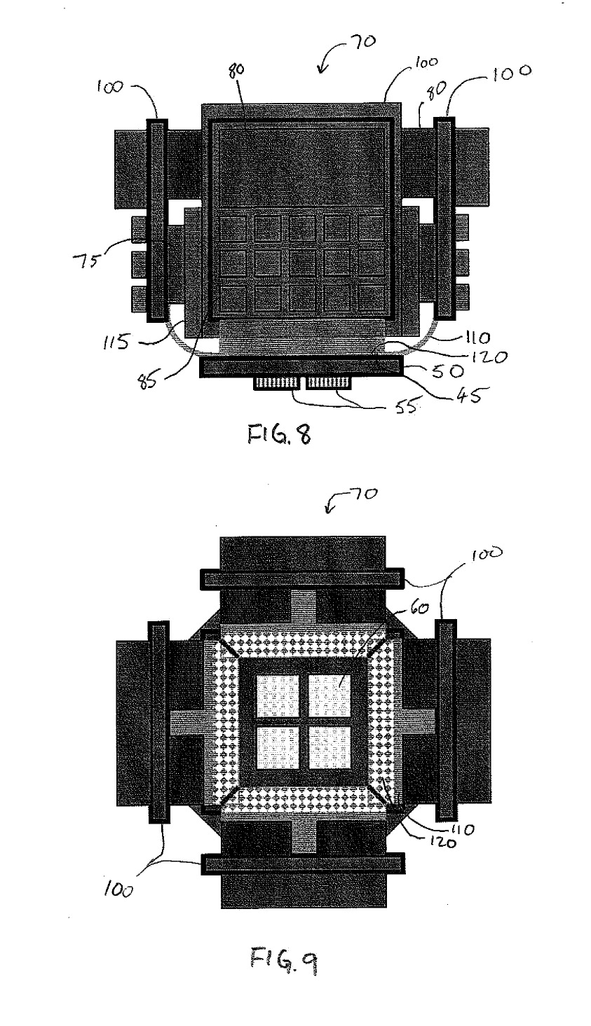

FIGS. 3 and 4 are a top and bottom view, respectively, of an individual detachable logic leaf 100 with power supplies 80, memory 85, and local processors 75 shown in an array pattern to allow maximum space efficiency on a DCA-Z Interconnect 65.

FIG. 5 is a sectional close-up side view of an individual detachable logic leaf 100, without power supplies 80, processors 75, and memory 85 attached. Flex lead 110 contains a dendritic metal structure 125 on one surface of flex connector 120. FIG. 6 is an enlarged close-up of the flex lead 110 flex connector 120 containing the dendritic metal structure 125. The dendritic structure comprises needle shaped protrusions extending from the copper contact pads made of palladium with a gold flash. These structures are in the order of 0.0005″ to 0.002″ high from the copper pad surface. The size and shape is determined by the final usage of these contacts. The finer structures are used for fine pitch interconnect commonly found in flip chip applications where the pitch is in the order of 150 microns to 250 microns. The larger structures is used in BGA applications where the pitch is 0.8 mm and greater.

FIGS. 7-9 are several views of an individual compute module 70 wherein FIG. 7 depicts three individual detachable logic leaf 100, containing power supplies 80, processors 75, and memory (not shown) attached in a zonal pattern to the compute module cluster interface board 50 by means of a coupling containing dendritic metal structure 125 and 45. These dendritic metal structures 45 and 125 serve to connect compute module cluster interface board 50 to flex lead 110 and encompass power, signal, and ground wires for transmission to various devices of individual detachable logic leaf 100. The partial compute module 70 of FIG. 7 is shown with center cooling structure 115 (FIG. 8) removed and three individual detachable logic leaves 100 shown folded outward. A fourth individual detachable logic leaf 100′ is depicted detached from compute module cluster interface board 50, and can be anticipated as being installed or removed as part of compute module 70 build-up or repair, respectively.

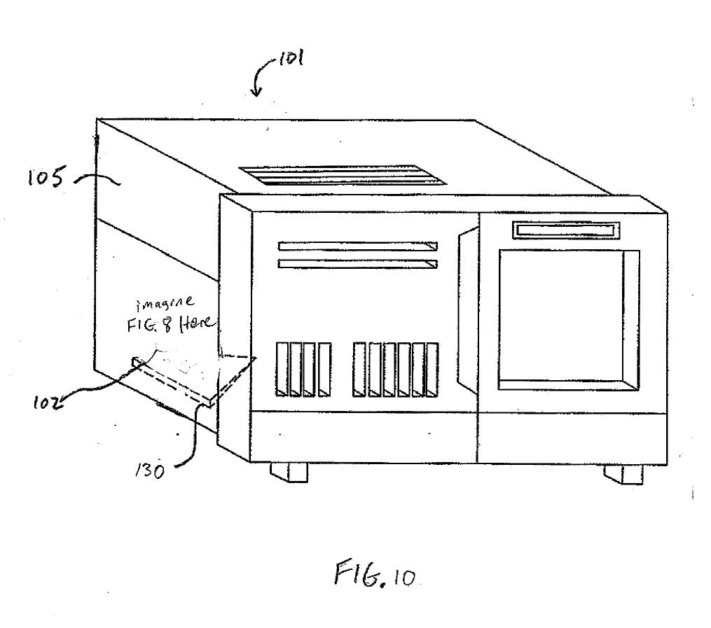

FIG. 8 is a side view of an individual compute module 70 that has electrical and optical connector 55 that is part of compute module cluster interface board 50 that forms the base of compute module 70 that allows the bidirectional exchange of information between compute module cluster interface board 50 and midplane 130 (FIG. 10).

Computer module cluster interface board 50 has electrical and optical connectors 55 that allow the interface of the midplane 130 to compute module 70 and facilitates the installation and removal of compute module 70. The flex lead 110 connects the computer module cluster interface board 50 to the DCA-Z Interconnect 65 by means of flexible substrate that encompasses power, signal, and ground wires to allow DCA-Z Interconnect 65 and associated components to move in an upward arc to contact coolant filled heat transfer block 115 to promote the conduction of heat away from processors 75 and power supply 80.

The flex leads 110, by folding in the aforementioned manner, allow a denser packing of compute module 70 and a compact footprint, thereby enabling more processing power per unit of volume. This allows the processors 75 to run at a higher processing frequency, thereby permitting more clock cycles per unit of time to allow more throughput on processor 75. The coolant filled heat transfer block 115 removes the heat generated by the processors 75 and power supplies 80 in normal operation and allows closer physical placement within a system than would be allowable using convection cooling only. Not shown in the views is a hollow transom containing coolant inlets and outlets for the movement of a coolant to and from coolant filled heat transfer block 115.

FIG. 9 is a top view of partial compute module 70 with center cooling structure removed and individual detachable logic leaf 100 shown folded upward. Flex lead 110 is connected to the compute module cluster interface board 50 by means of a coupling or flex connector 120. In this view module cluster connector blocks 60 can be seen. Memory 85, processors 75, and power supplies 80 can be seen arrayed on direct chip attach (DCA)-Z Interconnect 65 on individual detachable logic leaves 100 that are similar in structure. Other associated functions that are required for a computer to operate are not delineated here.

As stated, each flexible substrate formed in accordance with the teachings herein may be utilized within a larger substrate of known type such as a PCB, chip carrier or the like. FIG. 8 illustrates one of these components, individual compute module 70. Individual compute module 70 may be positioned within and electrically coupled to an information handling system (IHS) 101 as shown in FIG. 10, which may be in the form of a personal computer, mainframe, computer server, etc. Individual compute module 70, as shown, is typically electrically coupled to other PCBs to form a processing assemblage within IHS 101. As mentioned above, the invention is not limited to the numbers shown. For example, individual compute module 70, each forming part of a particular circuitized “core” (e.g., a “power core”) within the IHS 101 (FIG. 10), may be utilized to afford the PCB the highly advantageous teachings of the invention. Or, as stated, the entire PCB may be comprised of compute modules as taught here. Many different combinations are thus possible.

In FIG. 10, there is shown an information handling system (IHS) 101 in accordance with one embodiment of the invention. IHS 101 may comprise a personal computer, mainframe computer, computer server, or the like, several types of which are well known in the art. IHS 101, as taught herein, may include one or more of the electrical assemblies as shown in FIG. 8, including individual compute module 70, these being represented by numeral 102 (FIG. 10).

This completed assembly, hidden in FIG. 10, may be mounted on a still larger PCB or other substrate 80, one example being a motherboard of much larger size, should such a board be required. These components are hidden in FIG. 10 because they are enclosed within and thus behind a suitable housing 105 to accommodate the various electrical and other components which form part of IHS 101. Individual compute module 70 may instead comprise such a motherboard in IHS 101 and thus include additional electrical assemblies, including additional printed circuit cards mounted thereon, such additional cards in turn also possibly including additional electronic components as part thereof. It is thus seen that the electrical assemblies made in accordance with the unique teachings herein may be utilized in various structures as part of a much larger system, such as IHS 101. Further description is not believed necessary.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. An individual compute module comprising:
a) a cluster interface board for interconnecting electrical components; and
b) at least one module comprising a logic leaf module operatively connected to said cluster interface board, and a means for facilitating communication therebetween.

2. The individual compute module of claim 1, further comprising detachable electrical connections to said cluster interface board.

3. The individual compute module of claim 1, wherein said logic leaf module interconnects are flexible.

4. The individual compute module of claim 1, wherein means for facilitating communication comprise dendritic projections on said logic leaf module being operatively and detachably connected to dendritic projections on said cluster interface board.

5. The individual compute module of claim 1, wherein said cluster interface board comprises a plurality of sides.

6. A method of joining a detachable logic leaf device to a cluster interface board, the steps comprising:
a) providing a detachable logic leaf module device operatively connected to a flexible substrate connector having projections disposed on one surface having predetermined dimensions and a pitch thereof;
b) providing a cluster interface board with a receiving area site, said cluster interface board having projections disposed on one surface having predetermined dimensions and a pitch thereof;
c) operatively connecting said flexible substrate connector to said detachable logic leaf module device, said flexible substrate connector having projections disposed on one surface thereof, said projections having predetermined dimensions and pitch corresponding to said receiving area site of said cluster interface board, said projections being used in electrical communication through said flexible substrate with said detachable logic leaf module device; and
d) joining said flexible substrate connector of said detachable logic leaf module device to said receiving area site of said cluster interface board.

7. The method according to claim 6, wherein said joining step (d) is non-permanent, allowing said detachable logic leaf module device to be detached from said cluster interface board exclusive of tools.

8. The method according to claim 6, wherein said joining step (d) is accomplished by a compression process.

9. The method according to claim 6, wherein said joining step (d) is accomplished in two steps comprising:
i) a first step wherein the joining is temporary and said flexible substrate connector having projections is aligned with said receiving area site of cluster interface board after the first step; and
ii) based on the results of at least one test, a second step wherein the joining is made functionally complete by a subsequent process.

10. The method according to claim 9, wherein said joining step (d) is accomplished via compression comprising at least one stage, wherein:
a first step comprises alignment of flexible substrate connector having projections to said receiving area site of cluster interface board; and
a second step comprises a final compression wherein said detachable logic leaf module device and said cluster interface board are detachably joined together.

11. The method according to claim 9, wherein said compression of a vertical load of 25 to 85 psi is applied, said first step comprising a constant force application of said compression, and said second step comprising a final test of said electrical connections.

12. The method according to claim 10, wherein said compression comprises a first and a second step combination of pinch and roll, respectively, said first step comprising constant weight bearing pressure, and said second step comprising a rolling compression process.

13. The method according to claim 9, wherein said set of projections disposed on one surface are sculpted with protrusions, said recessed receiving area site have solder projections, said first step comprising insertion of said sculpted projections into said solder projections, and said second step comprising compressing said protrusions into said sculpted projections.
a) providing a detachable logic leaf module device operatively connected to a flexible substrate connector having a set of projections disposed on one surface thereof; and
b) providing a cluster interface board with said receiving area site for attaching a logic leaf module device, the cluster interface board having predetermined dimensions and a pitch.

14. The method according to claim 9, wherein said set of projections disposed on one surface are provided with dendritic protrusions, and said first step comprising insertion of said dendritic protrusions into said recessed receiving area site on said cluster interface board.

15. The method according to claim 9, wherein said set of projections disposed on one surface and said recessed receiving area site on said cluster interface board are provided with dendritic protrusions and valleys, and said first step comprises inserting said dendritic protrusions into the valleys of said recessed receiving area to form a detachable interdigitating interconnection.

16. The method according to claim 8, wherein said joining of said detachable logic leaf device to said cluster interface board is repeatedly reversible.

17. An information handling system (IHS) comprising:
a housing; and
a detachable logic leaf module comprising dendritic projections on a surface thereof and a recessed receiving area on a surface of a cluster interface board, said projections for electrically connecting a logic module device to said cluster interface board or the like, the projections on the surface of said logic leaf being conductively wired to said receiving area on the surface of the cluster interface board.

18. The IHS of claim 17, comprising a personal computer.

19. The IHS of claim 17, comprising a mainframe computer.

20. The IHS of claim 17, comprising a computer server.
